(19) United States
(12) Patent Application Publication
(10) Pub. No.: US 2015/0112648 A1
(43) Pub. Date: Apr. 23, 2015

(54) Simulated model comparison

(71) Applicant: Khalil Abu Al Rubb, Doha (QA)

(72) Inventor: Khalil Abu Al Rubb, Doha (QA)

(21) Appl. No.: 14/404,619

(22) PCT Filed: May 22, 2013
(86) PCT No.: PCT/GB2013/000236

§ 371 Date: Nov. 29, 2014

(30) Foreign Application Priority Data
May 31, 2012 (GB) 1209883.6

(51) Int. Cl. G06T 19/00; A41H 5/02

(52) U.S. Cl. CPC G06T 19/00; A41H 5/02; G06T 2210/16; G06T 2210/21
USPC 703/1

(57) ABSTRACT

A process for comparing the fit of two objects. A request is sent to compare the fit of two objects, a program loads two models, model 1 and model 2, corresponding to the two objects. The program simulates the first model, model 1, being fit inside the second model, model2. A result of the simulation is saved and the result is reported to a user.

The invention relates to a method of comparing the fit of an object within another object.

Prior to purchasing an item of clothing, it is prudent to try on the item to ensure that it provides a good fit for a body about which it is to be worn. If the clothing is bought too large, it may provide an unflattering fit to a wearer, but it should at least be wearable. If the clothing is bought too small, it may provide an uncomfortable fit or, at worst, be unwearable.

To avoid purchasing uncomfortable or unwearable items, items are tried on prior to purchase. This is usually performed in store in a changing room. Items may also be tried on in a private residence. When clothes are tried on in a residence, it is usual that the person trying the clothes on has to buy the item prior to it being delivered; however, should the item fit, the buyer retains the item, Should the item not fit, the buyer has to return the item to a seller and request a refund. Both above methods have associated disadvantages. It is often inconvenient to go to a shop to try on items of clothing. Further, the shop may not have a full range of clothes in every design and size, which could potentially mean that the visit to the shop is wasted as a particular item cannot be tried on in its full range of sizes. When trying on clothes in a residence, a clear inconvenience occurs if returning clothing to a seller is required.

Trying clothes on necessitates a person and an item of clothing not only to be in the same place, but also the physical act of trying on the clothing, which requires privacy and the availability of the clothing.

A solution to at least one of the above problems would be a method by which distance selling, such as Internet shopping, is facilitated by providing a method of distance fitting/trying on of an item of clothing.

An aspect of the invention provides a method of comparing the fit of objects comprising (i) loading a model of a first object into a computer memory; (ii) loading a model of a second object into the computer memory; (iii) simulating the first model positioned within the second model; and (iv) checking if the first model fits within the second model, and, if the first model does not fit within the second model: (v) loading a third object into the computer memory, wherein the third object is larger than the second object; (vi) simulating the first model positioned within the third model; and (vii) checking if the first model fits within the third model. An additional and larger model increases the likelihood that a model is found in which the first model will fit.

Preferably, if the first model does not fit within the second model, the method further comprises: (iv-1) altering the relative angle of the first object compared to the second object within a predetermined range of relative angles; and (vi) repeating steps iii, iv and iv-1. If the relative angle of the first and second models is changed, the first model may better fit within the second. The range of angles within which the objects are adjusted is limited to stop the objects being inverted or completely rotated in order to provide a fit. It is important that the relative orientation between the first and second models is kept constant in order to ensure the models fit together in a manner in which the objects that they were based upon were designed to fit together. Preferably, the method is repeated with a plurality of different relative angles. This increases the likelihood that the first model is able to be fitted within the second model.

Preferably, if the first model does not fit within the third model, the method further comprises: (viii) altering the relative angle of the first object compared to the third object within a predetermined range of relative angles; and (ix) repeating steps vi, vii and vii. Preferably, the method is repeated with a plurality of different relative angles. As described above, the relative angles of models are adjusted in an attempt to establish a fit for the first model within another model.

Preferably, the models of the first, second and third objects are elastic models. This provides a more realistic simulation when the real life objects upon which the models are based are themselves elastically deformable.

Preferably, a report is generated stating whether or not the first model fits inside any other model. Preferably, the report states if any fit requires elastic deformation of either or both models during a simulation step. The report provides a user of the system with information regarding fitting of the simulated models, i.e. whether any real life object is likely to fit and to what extend a fit requires deformation of either and/or both objects.

Preferably, the first model is a human body, and the second and third models are items of clothing. The system may be used to simulate the trying on of items of clothing.

Preferably, the first model is created by analysing measurements of human body and the second model is created by optically scanning an item of clothing. The first model is created in a simple manner which can be performed at home as it does not require any specialist equipment. The second model is created using special equipment to provide a precise model. Preferably, the item of clothing supported by an inflatable form when being scanned. The inflatable form provides an affordable and easy way to ready the clothing for scanning in an 3D scanner. The use of the inflatable form does not require any special training and is not likely to damage clothing.

The invention will now be described, by way of example only, with reference to the accompanying drawings, in which:

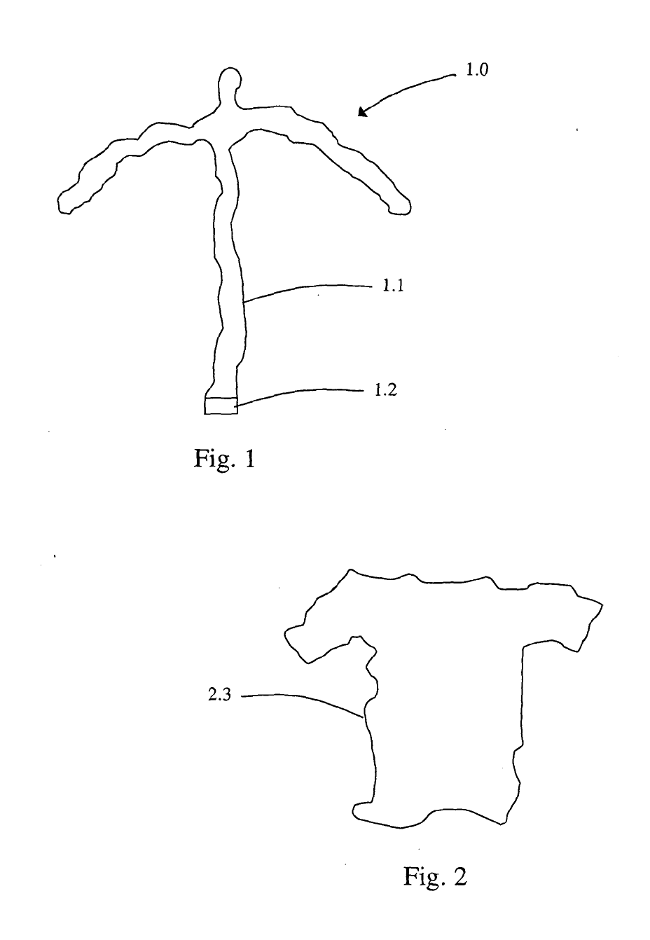

FIG. 1 is a front view of a deflated form;

FIG. 2 is a front view of an item of deformed clothing;

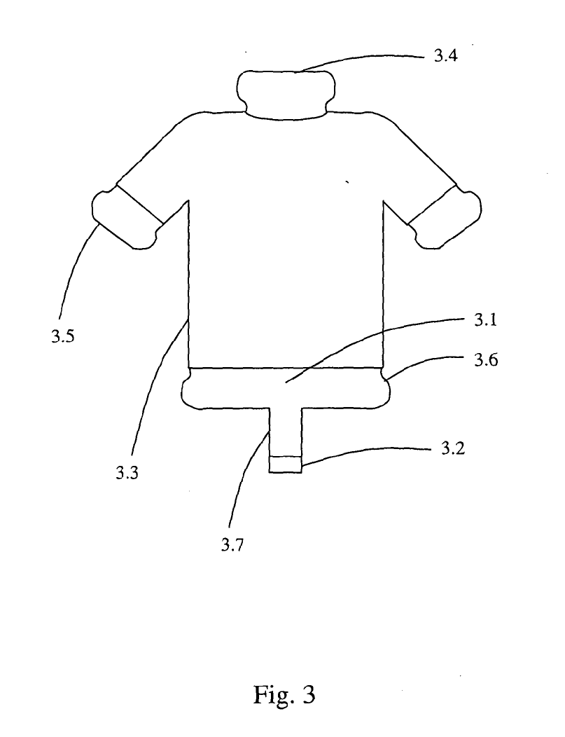

FIG. 3 is front view of the clothing over the form inflated;

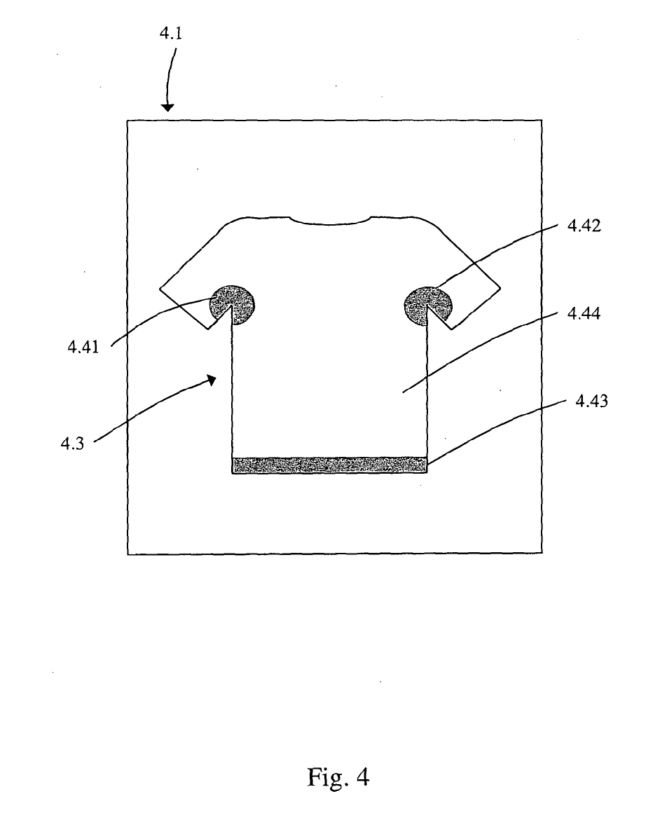

FIG. 4 is a view of a report;

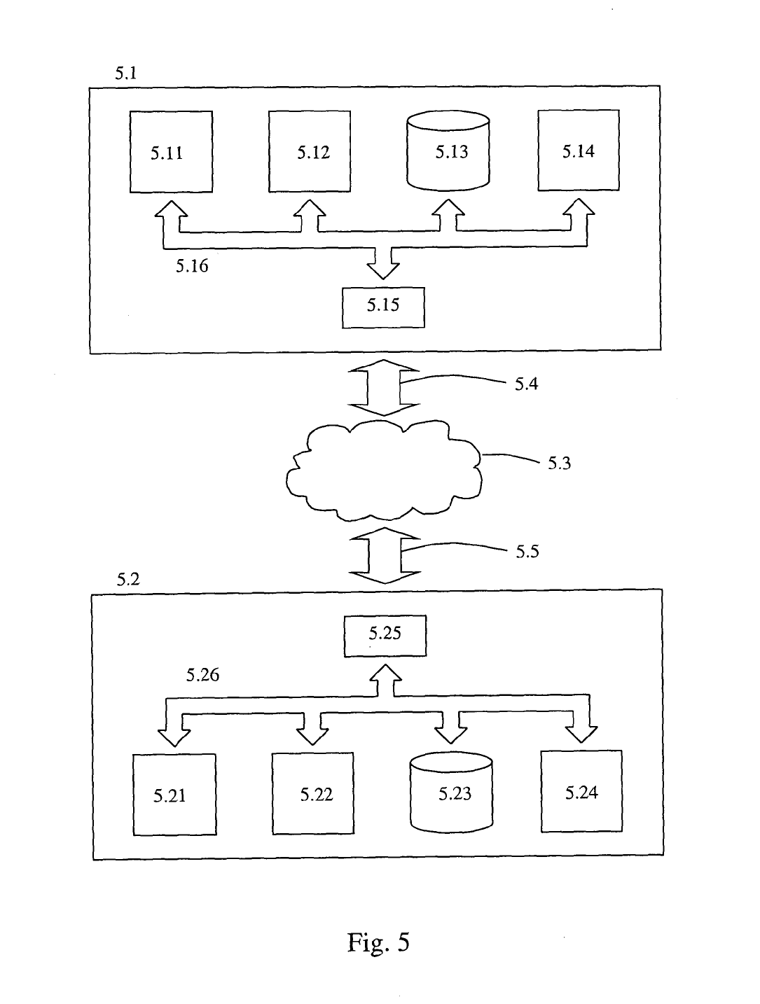

FIG. 5 is a view of a computer system;

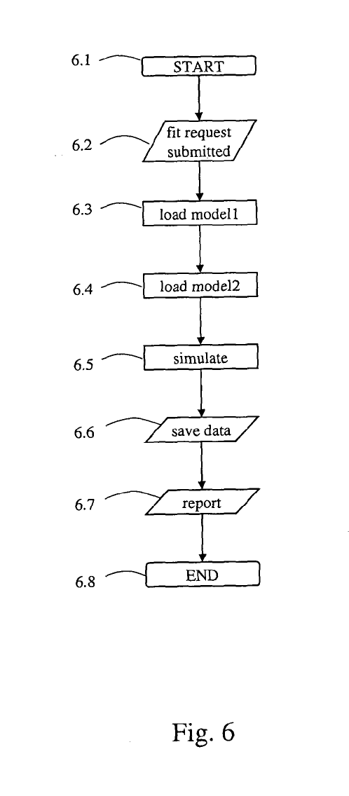

FIG. 6 is a first flow chart; and

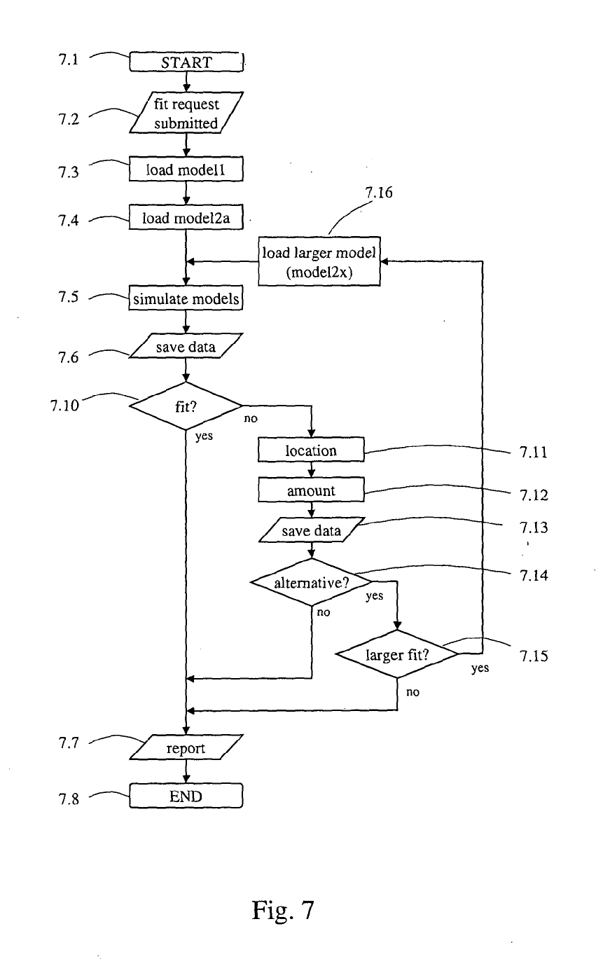

FIG. 7 is a second flow chart.

FIG. 1 shows a deflated form 1.0 comprising a deflated inflatable member 1.1 and a connector 1.2 coupled to the inflatable member. Fluid may be passed through the connector 1.2 and into the inflatable member 1.1. As the amount of fluid in the inflatable member 1.1 increases, the volume of the inflatable member also increases. In the embodiment shown in FIG. 1, the inflatable member 1.1 comprises a body section, coupled to the connector 1.2; two arm sections; and a neck section. The shape and size of an inflatable member may vary as they depend on the shape and size of an object in which the inflatable member is to be received.

FIG. 2 shows a piece of deformed clothing 2.3 in which the deflated form 1.0, of FIG. 1, is to be received.

In one embodiment, the inflatable member comprises multiple inflatable compartments. Each compartment is inflatable separately to provide different proportions to best fit into an item of clothing. There may be up to five separate compartments of the inflatable member.

FIG. 3 shows the deflated form 1.0, of FIG. 1, in an inflated state—an inflated inflatable member 3.1. The inflated member 3.1 fits inside the clothing 3.3 and is expanded into the clothing. At the top of the clothing 3.3, a neck section 3.4 of the inflated member 3.1 protrudes. At the sides of the clothing 3.3, arm sections 3.5 of the inflated member 3.1 protrude. At the bottom of the clothing, a waist section 3.6 of the inflated member 3.1 protrudes. The waste section 3.6 is coupled to a feed section 3.7 of the inflatable form. The feed section 3.7 is coupled to a connector 3.2 through which fluid may flow to either inflate or deflate the inflatable form. The expanded clothing 3.3 is scanned by a laser scanner to produce a three dimensional model representation of the clothing. Alternatively, the dimensions of the clothing may be manually measured at multiple points of the clothing and the measurements inputted into a computer which provides a model of the clothing.

FIG. 4 shows a report 4.1 produced by a system set out in FIGS. 6 and 7. The report 4.1 shows an image of a piece of clothing 4.3. The clothing 4.3 is shaded to represent the simulated fit of the clothing about an object. The clothing 4.3 displays a shaded first warning area 4.41, second warning area 4.42 and third warning area 4.43, and a non-shaded non-warned area 4.44.

The shaded areas 4.41, 4.42, 4.43 provide a visual representation of the fit of the clothing on/over an object. The colour and depth of shading represent the extend to which the clothing does not fit the object, i.e. the amount the clothing has to stretch in a particular area to cover the object.

FIG. 5 shows a system operable to perform the process of FIGS. 6 and 7. The upper box represents a first computer 5.1 and the lower box represents a second computer 5.2. The first computer 5.1 comprises a processor 5.11, memory 5.12, storage 5.13, computer input/output 5.14, data input/output 5.15 and bus 5.16. Computer programs and their related information can be stored by storage 5.13. The programs and their variables are loaded into memory 5.12 while the processor 5.11 operates on information provided by the program. Commands are received and display information is provided by the computer input/output 5.14. Data is received by and transmitted from the first computer 5.1 via the data input/output 5.15. Data is relayed internally within the first computer 5.21 by the data bus 5.16. The second computer 5.2 comprises a processor 5.21, memory 5.22, storage 5.23, computer input/output 5.24, data input/output 5.25 and bus 5.26. The components 5.21, 5.22, 5.23, 5.24, 5.25, 5.26 of the second computer 5.2 function in the same manner as the corresponding components 5.11, 5.12, 5.13, 5.14, 5.15, 5.16 of the first computer 5.1.

The first and second computers 5.1, 5.2 transmit and receive data over a network. The Internet 5.3 is the network and arrows 5.4, 5.5 represent the flow of information to/from the Internet to/from the first computer 5.1 and second computer 5.2, respectively. Any type of network may replace the Internet 5.3 for transmitting data between the first and second computers 5.1, 5.2.

The first computer 5.1 holds information relating to a model of a first object, such as a human body. This information is held by storage 5.13. The second computer 5.2 holds information relating to a model of a second object, such as an item of clothing. This information is held by storage 5.23. Further models may also be held by storage 5.23.

The second computer 5.2 may act as a server hosting a website providing models for the first computer 5.1, acting as a client, to access. Object simulation may take place on either the server or the client, with a report being provided to a user of the client.

FIG. 6 shows a process 6.1 - 6.8 for comparing the fit of two objects. When a request 6.2 is sent to compare the fit of two objects, a program loads two models 6.3, 6.4 (model1 and model2) corresponding to the two objects. The program simulates 6.5 the first model (model1) being fit inside the second model (model2). A result of the simulation is saved 6.6 and the result is reported 6.7 to a user. If the process 6.1-6.8 is repeated using the same models, the saved data is provided to the user for a report rather than repeating the simulation process to generate new data.

FIG. 7 shows a process 7.1-7.16 for comparing the fit of two or more objects. When a request 7.2 is sent to compare the fit of two objects, a program loads models 7.3, 7.4 (model1 and model2a) corresponding to each of the objects. The program simulates 7.5 the first model (model1) fit inside the second model (model2a) and a result of the simulation is saved 7.5. If 7.10 the first model (model1) fits inside the second model (model2a), the result is reported 7.7 to a user. If 7.10 the first model (model1) does not fit inside the second model (model2a), the location 7.11 of a section of the second model (model2a) that does not fit within the first model, and the amount 7.12 by which the second model does not fit within the first model are identified. The data for the misfitting part of the second model is saved 7.13.

A user of the process 7.1-7.16 can select 7.14 that alternative models representing other objects are simulated with the first model in order to identify an object that will fit over the first object (model1). If 7.14 no alternative should be simulated, the result of the simulation 7.5 is reported 7.7 to the user. If 7.14 an alternative to the second model (model2a) is to be simulated, another model (model2x) is loaded 7.16. The newly loaded model (model2x) is larger than the second model (model2a). The program simulates 7.5 the first model (model1) being fit inside the newly loaded model (model2x) and a result of the simulation is saved 7.5. The above described process of simulating larger models for the first model to fit into is repeated until either there are no larger models, or a fit is identified.

The alternative model selection step 7.14 may be an option provided to a user as required, or a system setting of a program carrying out the process.

Embodiments of the invention provide a more efficient method of remote item selection performed using electronic means.

1-16. (canceled)

17. A method of simulating the fit of an item of clothing to a human body comprising
i. creating a three dimensional body model, the body model being a representation of a human body;
ii. loading the body model into a computer memory;
iii. iii) loading a first clothing model into the computer memory, the first clothing model being representation of an item of clothing;
iv. simulating the body model positioned within the first clothing model;
v. checking the fit of the first clothing model around the body model;
vi. if the body model fits within the first clothing model, providing a visual representation of the simulated fit of the first clothing model around the body model;
vii. and if the body model does not fit within the first clothing model, loading a second clothing model into the computer memory, the second clothing model being a three dimensional representation of an item of clothing that is larger than that of the first model; and
viii. simulating the body model positioned within the second clothing model.

18. The method of claim 17, further comprising when the body model does not fit within the first clothing model, providing a visual representation of the body model within the second body model.

19. The method of claim 17, wherein the second clothing model is created prior to the step of simulating the body model positioned within the first clothing model.

20. The method of claim 17, wherein the first clothing model is elastic, and the visual representation shows the extent and location of elastic deformation required to position the body model within the first clothing model.

21. The method of claim 17, wherein the second clothing model is elastic, and when the body model does not fit within the first clothing model, the visual representation of the body model within the second clothing model shows the extent and location of elastic deformation required to position the body model within the second clothing model.

22. The method of claim 20, wherein the visual representation of the extent of elastic deformation is represented by depth of shading.

23. The method of claim 17, wherein creating the first clothing model includes scanning an item of clothing with a laser scanner.

24. The method of claim 23, wherein creating the first clothing model includes providing the clothing on an inflatable member, prior to the scanning.

25. The method of claim 24, wherein the inflatable member is shaped to represent a human torso.

26. The method of claim 24, wherein the inflatable member comprises multiple inflatable compartments, which may be inflated separately of one another.

27. The method of claim 17, further comprising providing a user with a report including details of the fit of the body model within the clothing model or clothing models.

28. A method of simulating the fit of an item of clothing to a human body, comprising:
i. locating an item of clothing around an inflatable member;
ii. inflating the inflatable member to expand the item of clothing;
iii. scanning the expanded item of clothing using a three dimensional scanner;
iv. creating a first virtual three dimensional clothing model from the scan, and loading the model into a computer;
v. simulating the fit of the body model within the clothing model;
vi. checking the fit of the first clothing model and body model; and
vii. displaying a visualisation of the fit of the first clothing model on the body model.

29. The method of claim 28, wherein the first clothing model is elastic, and the visualisation displays the extent and location of elastic deformation required to fit the clothing model around the body model.

30. The method of claim 28, further comprising creating a second virtual clothing models are created using the steps i. through iv. and,
when the body model does not fit within the first clothing model,
simulating the fit of the body model within the second clothing model
checking the fit of the second clothing model and the body model; and
displaying a visualisation of the second clothing model on the body model.

31. The method of claim 30, wherein the second clothing model is elastic, and the visualisation of the second clothing model on the body model displays the extent and location of elastic deformation required to fit the clothing model around the body model.

32. The method of claim 28, further comprising providing a user with a report including details of the fit of the body model within the clothing model.
